(19) United States
(12) Patent Application Publication
(10) Pub. No.: US 2006/0224556 A1
(43) Pub. Date: Oct. 5, 2006

(54) SQL interface for services

(75) Inventor: Naveen Gupta, Sunnyvale, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/340,950

(22) Filed: Jan. 27, 2006

Related U.S. Application Data
(60) Provisional application No. 60/665,964, filed on Mar. 29, 2005.

(51) Int. Cl. G06F 17/30

(52) U.S. Cl. 707/1

(57) ABSTRACT

In accordance with embodiments of the present invention, there are provided mechanisms and methods for providing an SQL interface for a service. These mechanisms and methods for providing an SQL interface for a service make it possible for data from a plurality of services to be provided to a requester so that the data appears to the requestor as having been organized into a single virtual SQL table. This ability of embodiments to provide data from a plurality of services to a requestor so that the data appears to the requestor as having been organized into a single virtual SQL table enables an SQL application making the SQL query to interface with the at least one of a plurality of services to obtain information using SQL format.

### CLAIM TO PRIORITY

The present application claims the benefit of:

U.S. Patent Application No. 60/665,964, entitled SQL INTERFACE FOR SERVICES, by Naveen Gupta, filed Mar. 29, 2005 (Attorney Docket No. BEAS-01753us07).

### CROSS REFERENCE TO RELATED APPLICATIONS

The following commonly owned, co-pending United States Patents and Patent Applications, including the present application, are related to each other. Each of the other patents/applications are incorporated by reference herein in its entirety:

U.S. Provisional Patent Application No. 60/665,908 entitled “LIQUID DATA SERVICES”, filed on Mar. 28, 2005, Attorney Docket No. BEAS 1753US0;

U.S. Provisional Patent Application No. 60/666,079 entitled “MODELING FOR DATA SERVICES”, filed on Mar. 29, 2005, Attorney Docket No. BEAS 1753US1;

U.S. Provisional Patent Application No. 60/665,768 entitled “USING QUERY PLANS FOR BUILDING AND PERFORMANCE TUNING SERVICES”, filed on Mar. 28, 2005, Attorney Docket No. BEAS 1753US2;

U.S. Provisional Patent Application No. 60/665,696 entitled “SECURITY DATA REDACTION”, filed on Mar. 28, 2005, Attorney Docket No. BEAS 1753US3;

U.S. Provisional Patent Application No. 60/665,667 entitled “DATA REDACTION POLICIES”, filed on Mar. 28, 2005, Attorney Docket No. BEAS 1753US4;

U.S. Provisional Patent Application No. 60/665,944 entitled “SMART SERVICES”, filed on Mar. 29, 2005, Attorney Docket No. BEAS 1753US5;

U.S. Provisional Patent Application No. 60/665,943 entitled “AD HOC QUERIES FOR SERVICES”, filed on Mar. 29, 2005, Attorney Docket No. BEAS 1753US6; and

U.S. Provisional Patent Application No. 60/665,964 entitled “SQL INTERFACE FOR SERVICES”, filed on Mar. 29, 2005, Attorney Docket No. BEAS 1753US7.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to accessing services on behalf of applications, and more particularly to a mechanism for providing an SQL interface for a service.

### BACKGROUND

Increasingly, enterprises are looking for ways to simplify access and organization of Information Technology (IT) services. One mechanism for providing such IT simplification is Service Oriented Architecture (SOA). Application of SOA principles promises faster development cycles, increased reusability and better change tolerance for software components.

Unfortunately, enterprises that implement SOA often find that the start-up complexities of SOA delays, if not derails, the expected return on investment. While SOA simplifies the complexity of an IT environment, organizations lack sufficient experience with SOA technology required for a quick, trouble-free implementation. Compounding this experience gap, graphical tools for implementing SOA are not readily available, so that data services for use in SOA environments often must be hand-coded.

One area in the enterprise-class portal and Web applications areas that receives significant developer time and attention, for example, is the perceived need to make applications and services available to as broad an audience as possible. From the point-of-view of a user, the service should be available using whatever mechanism the user would like to use to interface with the service. Accordingly, there is an ongoing need for improved techniques for enabling greater numbers of applications to interact with services via the SOA enabled server.

### BRIEF DESCRIPTION OF THE DRAWINGS

FIGS. 1A-1B are functional block diagrams illustrating an example computing environment in which techniques for providing an SQL interface for a service may be implemented in one embodiment.

FIG. 2A is an operational flow diagram illustrating a high level overview of a technique for providing an SQL interface for a service of one embodiment of the present invention.

FIG. 2B is an operational flow diagram illustrating a high level overview of a client process operable with the technique for accessing a service illustrated in FIG. 2A.

FIG. 3 is an operational flow diagram illustrating a high level overview of an example application employing one technique for accessing services and applying SQL format commands to a result set according indications received from a requestor in one embodiment of the present invention.

FIG. 4 is a hardware block diagram of an example computer system, which may be used to embody one or more components of an embodiment of the present invention.

### DETAILED DESCRIPTION

In accordance with embodiments of the present invention, there are provided mechanisms and methods for providing an SQL interface for a service. These mechanisms and methods for providing an SQL interface for a service make it possible for data from a plurality of services to be provided to a requestor so that the data appears to the requester as having been organized into a single virtual SQL table. This ability of embodiments to provide data from a plurality of services to a requestor so that the data appears to the requestor as having been organized into a single virtual SQL table enables an SQL application making the SQL query to interface with the at least one of a plurality of services to obtain information using SQL format.

In one embodiment, the invention provides a method for providing an SQL interface for a service. One embodiment of the method includes receiving an SQL query. A request to access at least one of a plurality of services based upon the SQL query is prepared. The request is prepared in a form that a service is able to understand. In one embodiment, the request is prepared by mapping the SQL query to an XQuery request for accessing the service(s). The at least one of a plurality of services is accessed using the request to obtain a result set. A virtual SQL table comprising data selected from the result set responsive to the SQL query is prepared.

As used herein, the term service is intended to be broadly construed to include any application, program or process resident on one or more computing devices capable of providing services to a requestor or other recipient, including without limitation network based applications, web based server resident applications, web portals, search engines, photographic, audio or video information storage applications, e-Commerce applications, backup or other storage applications, sales/revenue planning, marketing, forecasting, accounting, inventory management applications and other business applications and other contemplated computer implemented services. The term result set is intended to be broadly construed to include any result provided by one or more services. Result sets may include multiple entries into a single document, file, communication or other data construct. As used herein, the term view is intended to be broadly construed to include any mechanism that provides a presentation of data and/or services in a format suited for a particular application, service, client or process. The presentation may be virtualized, filtered, molded, or shaped. For example, data returned by services to a particular application (or other service acting as a requestor or client) can be mapped to a view associated with that application (or service). Embodiments can provide multiple views of available services to enable organizations to compartmentalize or streamline access to services, increasing the security of the organization's IT infrastructure.

As used herein, the term virtual SQL table is intended to be broadly construed to include any finctional equivalent to a real SQL table. Some examples of virtual SQL tables include without limitation, a virtual SQL table comprising data about customers. An application in a business environment may use an SQL query statement such as “SELECT [ALL|DISTINCT] columname1 [,columnname2] FROM tablename1 [,tablename2] [WHERE condition] [and|or condition. . . ] [GROUP BY column-list] [HAVING “conditions] [ORDER BY “column-list” [ASC|DESC] ]” in conjunction with an invocation of one or more services for customer information, “getCustomer( )” in order to perform the indicated selection operation(s) on the results returned from the getCustomer function. For example, in a banking application, a requestor at the bank may specify an SQL select statement to operate on retrieved information in a virtual SQL table named “Customers” to the customer entries having a balance in the “balance” column of the virtual SQL table “WHERE balance>100,000” in order to limit the customers returned a getCustomer query returns to only high net worth customers. In a manufacturing example, a requestor in accounting may specify SELECT Order_amount column from the Orders_table virtual SQL table WHERE “order amount<=300,000 units” to see only results of smaller orders in the work in progress (WIP) residing on the factory floor. In the telecommunications field, a requestor desirous of viewing network nodes capable of handling a large bandwidth may specify an SQL statement SELECT Node_bandwidth column from the Nodes_table virtual SQL table WHERE “bandwidth>1 Mps” for a query requesting node identities in the network in order to cause the server to eliminate any nodes not capable of supporting at least this bandwidth. These and other applications can be enabled by some of the many embodiments provided by the present invention. It is noteworthy that different implementations for the Select command may exist. Accordingly, the foregoing examples are intended to be illustrative and not limiting of the many different applications enabled by various embodiments.

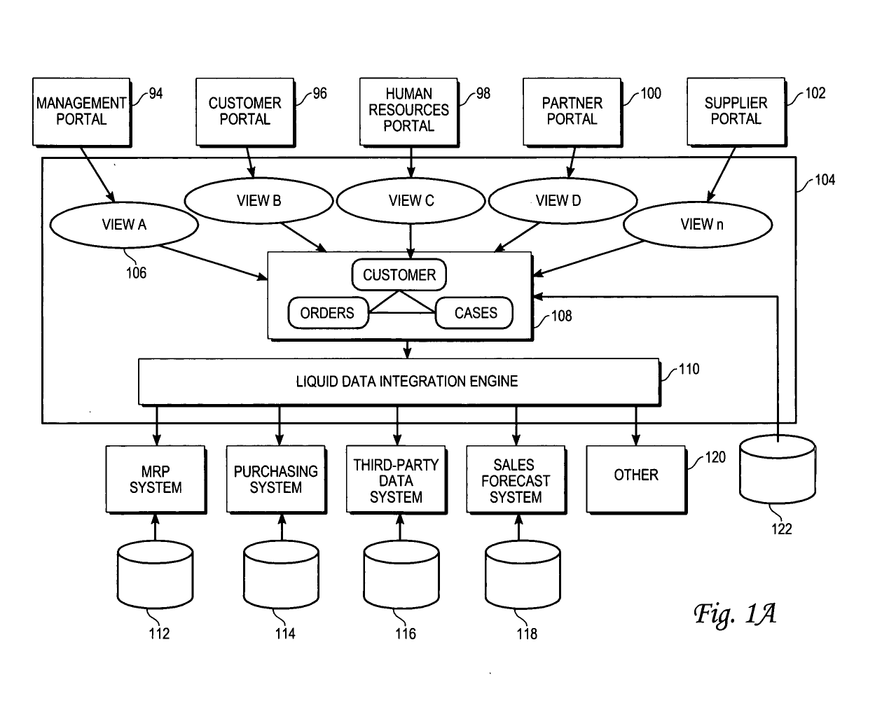

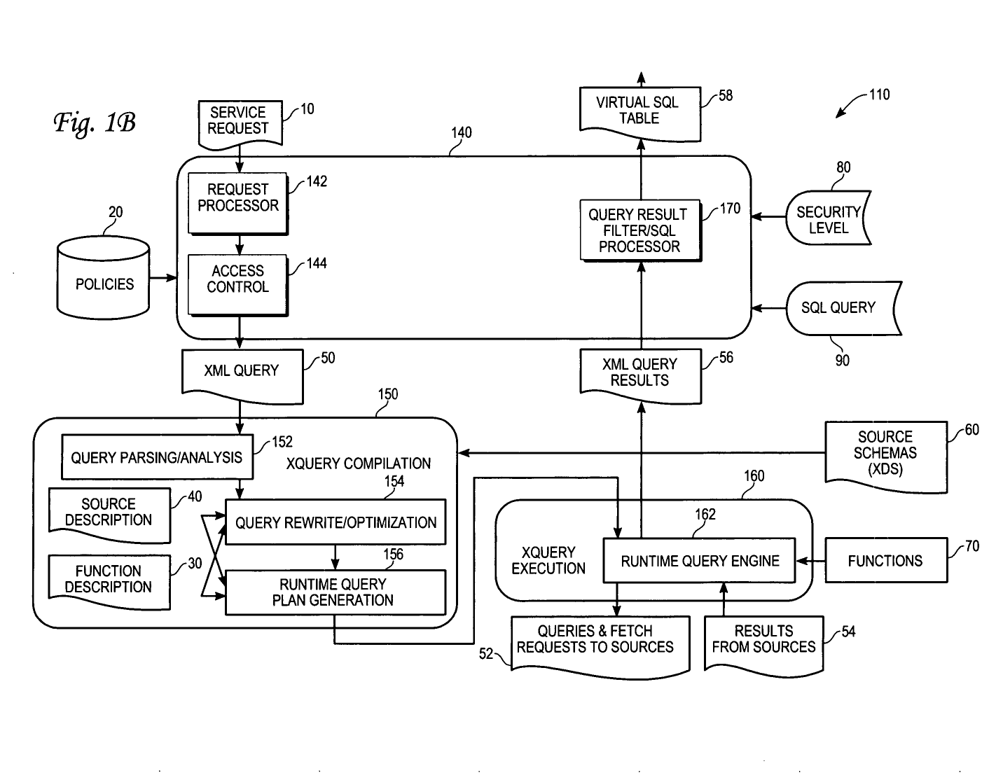

FIGS. 1A-1B are functional block diagrams illustrating an example computing environment in which techniques for data redaction may be implemented in one embodiment. As shown in FIG. 1A, a liquid data framework 104 is used to provide a mechanism by which a set of applications, or application portals 94, 96, 98, 100 and 102, can integrate with, or otherwise access in a tightly couple manner, a plurality of services. Such services may include a Materials Requirements and Planning (MRP) system 112, a purchasing system 114, a third-party relational database system 116, a sales forecast system 118 and a variety of other data-related services 120. Although not shown in FIG. 1A for clarity, in one embodiment, one or more of the services may interact with one or more other services through the liquid data framework 104 as well.

Internally, the liquid data framework 104 employs a liquid data integration engine 110 to process requests from the set of portals to the services. The liquid data integration engine 110 allows access to a wide variety of services, including data storage services, server-based or peer-based applications, Web services and other services capable of being delivered by one or more computational devices are contemplated in various embodiments. A services model 108 provides a structured view of the available services to the application portals 94, 96, 98, 100 and 102. In one embodiment, the services model 108 provides a plurality of views 106 that may be filtered, molded, or shaped views of data and/or services into a format specifically suited for each portal application 94, 96, 98, 100 and 102. In one embodiment, data returned by services to a particular application (or other service acting as a requestor or client) is mapped to the view 106 associated with that application (or service) by liquid data framework 104. Embodiments providing multiple views of available services can enable organizations to compartmentalize or streamline access to services, thereby increasing the security of the organization's IT infrastructure. In one embodiment, services model 108 may be stored in a repository 122 of service models. Embodiments providing multiple services models can enable organizations to increase the flexibility in changing or adapting the organization's IT infrastructure by lessening dependence on service implementations.

FIG. 1B is a high level schematic of a liquid data integration engine 110 illustrated in FIG. 1A with reference to one example embodiment. As shown in FIG. 1B, the liquid data integration engine 110 includes an interface processing layer 140, a query compilation layer 150 and a query execution layer 160. The interface layer 140 includes a request processor 142, which takes the request 10 and processes this request into an XML query 50. Interface layer 140 also includes access control mechanism 144, which determines based upon a plurality of policies 20 whether the client, portal application, service or other process making the request 10 is authorized to access the resources and services required to satisfy the request. Provided that the client, application, service or other process is authorized to make the request 10, the interface layer sends the XML query 50 to the query compilation layer 150.

Within the query compilation layer 150, a query parsing and analysis mechanism 152 receives the query 50 from the client applications, parses the query and sends the results of the parsing to a query rewrite optimizer 154. The query rewrite optimizer 154 determines whether the query can be rewritten in order to improve performance of servicing the query based upon one or more of execution time, resource use, efficiency or other performance criteria. The query rewrite optimizer 154 may rewrite or reformat the query based upon input from one or more of a source description 40 and a function description 30 if it is determined that performance may be enhanced by doing so. A runtime query plan generator 156 generates a query plan for the query provided by the query rewrite optimizer 154 based upon input from one or more of the source description 40 and the function description 30.

The query compilation layer 150 passes the query plan output from the runtime query plan generator 156 to a runtime query engine 162 in the query execution layer 160. The runtime query engine 162 is coupled with one or more functions 70 that may be used in conjunction with formulating queries and fetch requests to sources 52, which are passed on to the appropriate service(s). The service responds to the queries and fetch requests 52 with results from sources 54. The runtime query engine 162 of the query execution layer 160 translates the results into a format usable by the client or portal application, such as without limitation XML, in order to form the XML query results 56.

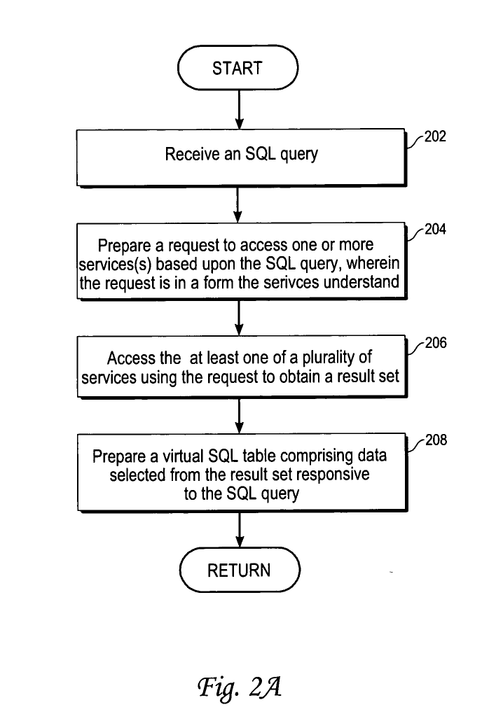

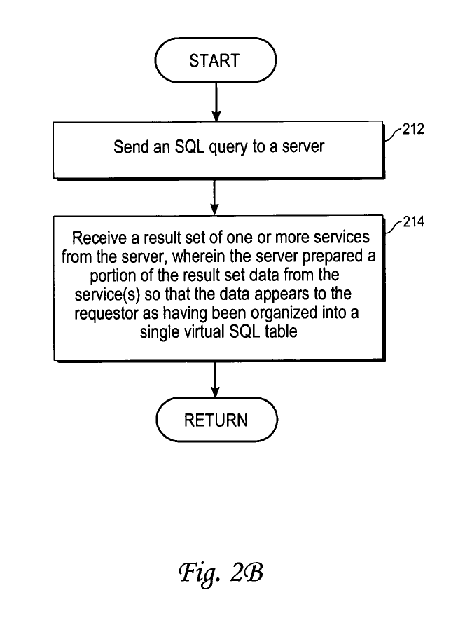

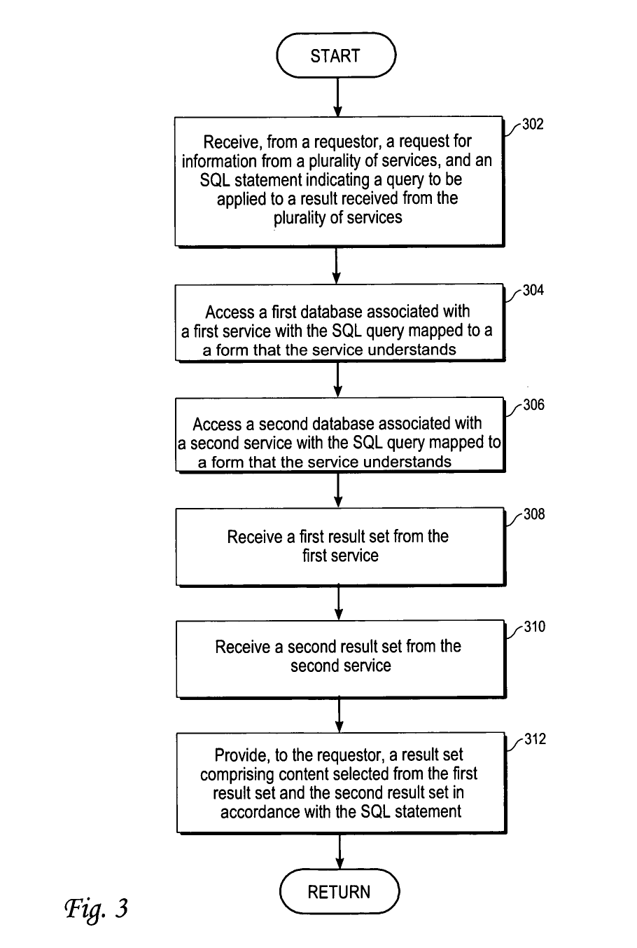

Before responses or results 56 are passed back to the client or portal application making the request, a query result filter 146 in the interface layer 140 determines based upon an SQL query 90 what portion of the results will be passed back to the client or portal application and in what form or format, forming a virtual SQL table 58. Although not shown in FIG. 1B for clarity, SQL query 90 may accompany service request 10 in one embodiment. Further, query result filter 146 also determines based upon access policies implementing security levels 80 what portions of the virtual SQL table 58 a requestor is permitted to access and may redact the virtual SQL table accordingly. Although not shown in FIG. 1B for clarity, access policies implementing security levels 80 may be stored with policies 20 in one embodiment. Techniques for providing an SQL interface for a service implemented by query result filter/SQL processor 170 will be described below in greater detail with reference to FIGS. 2A-3. When properly formed, the response is returned to the calling client or portal application.

FIG. 2A is an operational flow diagram illustrating a high level overview of a technique for providing an SQL interface for a service of one embodiment of the present invention. The technique for providing an SQL interface for a service shown in FIG. 2A is operable with an application sending data, such as Materials Requirements and Planning (MRP) system 112, an purchasing system 114, a third-party relational database system 116, sales forecast system 118, or a variety of other data-related services 120 of FIG. 1A, for example. As shown in FIG. 2A, an SQL query is received (block 202). A request to access at least one of a plurality of services based upon the SQL query is prepared (block 204). The request is prepared in a form that a service is able to understand. In one embodiment, the request is prepared by mapping the SQL query to an XQuery request for accessing the service(s). The at least one of a plurality of services is accessed (block 206) using the request to obtain a result set. A virtual SQL table comprising data selected from the result set responsive to the SQL query is prepared (block 208). In one embodiment, the method illustrated by blocks 202-208 may be advantageously disposed in the interface processing layer 140, query compilation layer 150 and query execution layer 160 of FIG. 1B.

FIG. 2B is an operational flow diagram illustrating a high level overview of a client process operable with the technique for accessing a service illustrated in FIG. 2A. The technique for receiving data from a service via an SQL interface shown in FIG. 2B is operable with an application sending data, such as applications application 94, 96, 98, 100 and 102 of FIG. 1A, for example or a service, such as Materials Requirements and Planning (MRP) system 112, an purchasing system 114, a third-party relational database system 116, sales forecast system 118, or a variety of other data-related services 120 of FIG. 1A. As shown in FIG. 2B, a request to access a service is sent to a server (block 212). A result set is received (block 214) from the server. The result set includes a portion that has been prepared by the server from one or more services so that the data appears to the requestor as having been organized into a single virtual SQL table.

FIG. 3 is an operational flow diagram illustrating a high level overview of an example application employing one technique for accessing services and applying SQL format commands to a result set according indications received from a requestor in one embodiment of the present invention. The technique for accessing a service shown in FIG. 3 is operable with an application sending data, such as the applications described above with reference to FIG. 2A. As shown in FIG. 3, a request for information from a plurality of services, and an SQL statement indicating a query to be applied to a result received from the plurality of services are received from a requestor (block 302). A first database associated with a first service is accessed (block 304) using the SQL query mapped to a form that the service understands. A second database associated with a second service is accessed (block 306) using the SQL query mapped to a form that the service understands. A first result set is received from the first service (block 308). A second result set is received from the second service (block 310). A result set comprising content selected from the first result set and the second result set is provided to the requestor as a virtual SQL table in accordance with the SQL statement (block 312). In one embodiment, at least one of the first database and the second database is a non-SQL format database.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for providing an SQL interface for a service as discussed herein.

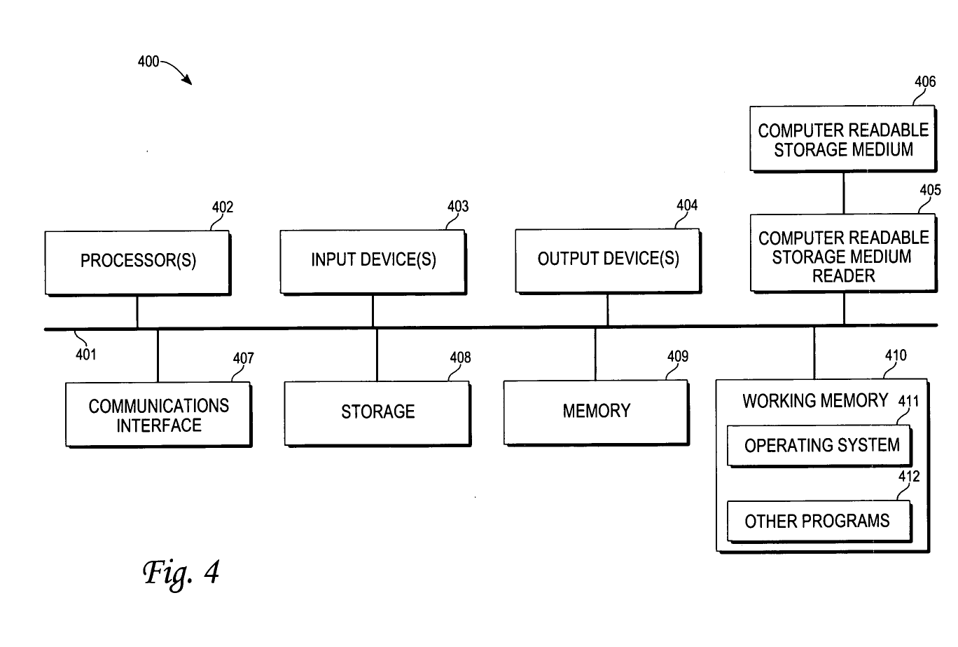

FIG. 4 illustrates an exemplary processing system 400, which can comprise one or more of the elements of FIGS. 1A and 1B. Turning now to FIG. 4, an exemplary computing system is illustrated that may comprise one or more of the components of FIGS. 1A and 1B. While other alternatives might be utilized, it will be presumed for clarity sake that components of the systems of FIGS. 1A and 1B are implemented in hardware, software or some combination by one or more computing systems consistent therewith, unless otherwise indicated.

Computing system 400 comprises components coupled via one or more communication channels (e.g., bus 401) including one or more general or special purpose processors 402, such as a Pentium®, Centrino®, PowerPC®, digital signal processor (“DSP”), and so on. System 400 components also include one or more input devices 403 (such as a mouse, keyboard, microphone, pen, and so on), and one or more output devices 404, such as a suitable display, speakers, actuators, and so on, in accordance with a particular application. (It will be appreciated that input or output devices can also similarly include more specialized devices or hardware/software device enhancements suitable for use by the mentally or physically challenged.)

System 400 also includes a computer readable storage media reader 405 coupled to a computer readable storage medium 406, such as a storage/memory device or hard or removable storage/memory media; such devices or media are further indicated separately as storage 408 and memory 409, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 407 may also be included, such as a modem, DSL, infrared, RF or other suitable transceiver, and so on for providing inter-device communication directly or via one or more suitable private or public networks or other components that may include but are not limited to those already discussed.

Working memory 410 further includes operating system (“OS”) 411 elements and other programs 412, such as one or more of application programs, mobile code, data, and so on for implementing system 400 components that might be stored or loaded therein during use. The particular OS or OSs may vary in accordance with a particular device, features or other aspects in accordance with a particular application (e.g. Windows, WindowsCE, Mac, Linux, Unix or Palm OS variants, a cell phone OS, a proprietary OS, Symbian, and so on). Various programming languages or other tools can also be utilized, such as those compatible with C variants (e.g., C++, C#), the Java 2 Platform, Enterprise Edition (“J2EE”) or other programming languages in accordance with the requirements of a particular application. Other programs 412 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 408 or memory 409) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for providing an SQL interface for a service, the method comprising:
receiving an SQL query;
preparing a request to access at least one of a plurality of services based upon the SQL query, wherein the request is prepared in a format that a service is able to understand;
accessing the at least one of a plurality of services using the request to obtain a result set; and
preparing a virtual SQL table comprising data selected from the result set responsive to the SQL query.

2. The method of claim 1, wherein preparing a virtual SQL table comprising data selected from the result set responsive to the SQL query comprises:
providing data from the plurality of services to the requestor so that the data appears to the requestor as having been organized into a single virtual SQL table.

3. The method of claim 1, wherein receiving an SQL query comprises:
receiving an invocation of a service comprising an embedded SQL command.

4. The method of claim 1, wherein the at least one of a plurality of services comprises an XQuery interface; and wherein preparing a virtual SQL table comprising data selected from the result set responsive to the SQL query enables an SQL application making the SQL query to interface with the at least one of a plurality of services to obtain information using SQL format.

5. The method of claim 1, wherein preparing a request to access at least one of a plurality of services based upon the SQL query comprises:
mapping the SQL query to an XQuery request for accessing at least one of a plurality of services.

6. The method of claim 5, wherein mapping the SQL query to an XQuery request for accessing at least one of a plurality of services comprises:
determining whether syntax of the SQL query and preparing the XQuery request if the syntax of the SQL query is correct.

7. The method of claim 6, further comprising:
determining to refrain from preparing the XQuery request if the syntax of the SQL query is not correct.

8. The method of claim 1, wherein service includes a computer resident application capable of providing services to a requestor or other recipient.

9. The method of claim 8, wherein service include at least one selected from: network based applications, web based server resident applications, web portals, search engines, photographic, audio or video information storage applications, e-Commerce applications, backup or other storage applications, sales/revenue planning, marketing, forecasting, accounting and inventory management applications.

10. A method for receiving data from a service via an SQL interface, comprising:
sending an SQL query to a server; and
receiving a result set from the server; wherein the server has prepared a portion of the result set data from at least one of a plurality of services so that the data appears to the requestor as having been organized into a single virtual SQL table.

11. A computer-readable medium carrying one or more sequences of instructions for providing an SQL interface for a service, which instructions, when executed by one or more processors, cause the one or more processors to carry out the steps of:
receiving an SQL query;
preparing a request to access at least one of a plurality of services based upon the SQL query, wherein the request is prepared in a format that a service is able to understand;
accessing the at least one of a plurality of services using the request to obtain a result set; and
preparing a virtual SQL table comprising data selected from the result set responsive to the SQL query.

12. The computer-readable medium as recited in claim 11, wherein the instructions for carrying out the step of preparing a virtual SQL table comprising data selected from the result set responsive to the SQL query further comprise instructions for carrying out the steps of:
providing data from the plurality of services to the requestor so that the data appears to the requestor as having been organized into a single virtual SQL table.

13. The computer-readable medium as recited in claim 11, wherein the instructions for carrying out the step of receiving an SQL query further comprise instructions for carrying out the steps of:
receiving an invocation of a service comprising an embedded SQL command.

14. The computer-readable medium as recited in claim 11, wherein the at least one of a plurality of services comprises an XQuery interface; and wherein the instructions for carrying out the step of preparing a virtual SQL table comprising data selected from the result set responsive to the SQL query enables an SQL application making the SQL query to interface with the at least one of a plurality of services to obtain information using SQL format.

15. The computer-readable medium as recited in claim 11, wherein the instructions for carrying out the step of preparing a request to access at least one of a plurality of services based upon the SQL query further comprise instructions for carrying out the steps of:
mapping the SQL query to an XQuery request for accessing at least one of a plurality of services.

16. The computer-readable medium as recited in claim 15, wherein the instructions for carrying out the step of mapping the SQL query to an XQuery request for accessing at least one of a plurality of services further comprise instructions for carrying out the steps of:
determining whether syntax of the SQL query and preparing the XQuery request if the syntax of the SQL query is correct.

17. The computer-readable medium as recited in claim 16, further comprising instructions for carrying out the steps of:
determining to refrain from preparing the XQuery request if the syntax of the SQL query is not correct.

18. The computer-readable medium as recited in claim 11, wherein service includes a computer resident application capable of providing services to a requestor or other recipient.

19. The computer-readable medium as recited in claim 18, wherein service include at least one selected from: network based applications, web based server resident applications, web portals, search engines, photographic, audio or video information storage applications, e-Commerce applications, backup or other storage applications, sales/revenue planning, marketing, forecasting, accounting and inventory management applications.

20. An apparatus for providing an SQL interface for a service, the apparatus comprising:
a processor; and
one or more stored sequences of instructions which, when executed by the processor, cause the processor to carry out the steps of:
receiving an SQL query;
preparing a request to access at least one of a plurality of services based upon the SQL query, wherein the request is prepared in a format that a service is able to understand;
accessing the at least one of a plurality of services using the request to obtain a result set; and
preparing a virtual SQL table comprising data selected from the result set responsive to the SQL query.
